(19) United States
(12) Patent Application Publication
(10) Pub. No.: US 2022/0094713 A1
(43) Pub. Date: Mar. 24, 2022

(54) MALICIOUS MESSAGE DETECTION

(71) Applicant: Sophos Limited, Abingdon (GB)

(72) Inventors: Younghoo Lee, Asquith (AU); Joshua Daniel Saxe, Wichita, KS (US); Richard Edward Harang, Alexandria, VA (US)

(21) Appl. No.: 17/480,556

(22) Filed: Sep. 21, 2021

Related U.S. Application Data
(60) Provisional application No. 63/081,209, filed on Sep. 21, 2020.

(51) Int. Cl. H04L 29/06; G06K 9/62

(52) U.S. Cl. CPC H04L 63/1483; H04L 63/145; G06K 9/6256; H04L 63/1425; H04L 63/1416

(57) ABSTRACT

In a natural language processing model such as a Bidirectional Encoder Representations from Transformers (BERT) model, transformer layers can be replaced with simplified adapters without significant loss of predictive ability. This compressed model may in turn be trained to perform security classification tasks such as detection of new phishing attacks in electronic mail communications.

### CROSS-REFERENCE TO RELATED APPLICATIONS

This application claims priority to U.S. Provisional Patent Application No. 63/081,209 filed on Sep. 21, 2020, the entire content of which is hereby incorporated by reference.

### BACKGROUND

In the field of cybersecurity, a phishing attack may involve a fraudulent message such as an email being sent to a recipient to entice the recipient to take an action of benefit to an attacker, such as clicking a link or downloading a file. It can be challenging to identify social engineered emails, particularly those that do not contain malicious code and do not share word choices with known attacks and may appear different in only subtle ways from benign messages. Such messages pose a significant challenge for conventional detection systems, particularly those that rely on duplication between previously seen and new malicious emails for identification.

There remains a need for improved malware detection using machine learning techniques.

### SUMMARY

In a natural language processing model such as a Bidirectional Encoder Representations from Transformers (BERT) model, transformer layers can be replaced with simplified adapters without significant loss of predictive ability. This compressed model may in turn be trained to perform security classification tasks such as detection of new phishing attacks in electronic mail communications.

In one aspect, a computer program product described herein includes computer executable code embodied in a non-transitory computer readable medium that, when executing on one or more computing devices, performs the steps of: training a teacher network including a first plurality of transformer layers to perform natural language processing using a large-scale natural language data set; training a student network with a second plurality of transformer layers less than the first plurality of transformer layers to reproduce functions of the teacher network in a compressed model; replacing at least one of the second plurality of transformer layers with an adapter first model to perform a natural language processing task to form a plurality of trained layers; generating a second model by replacing a subset of trained layers in the second plurality of transformer layers of the student network with a number of adapters; training the second model to perform a security classification task by fine-tuning the second model with a labelled target dataset specific to phishing detection; and provisioning the second model in an enterprise network to perform the security classification task.

The natural language processing may include next sentence prediction or masked word prediction. The teacher network may include a Bidirectional Encoder Representation from Transformers model. At least one of the number of adapters may include a randomly initialized, trainable adapter block interconnecting two of the transformer layers. At least one of the number of adapters may include a fully connected dense layer having a same dimensionality as the second plurality of transformer layers. At least one of the number of adapters may include an activation function for scaling inputs to outputs. Provisioning the second model may include deploying the second model on a threat management facility for the enterprise network. Provisioning the second model may also or instead include deploying the second model on an endpoint associated with the enterprise network.

In another aspect, a method described herein includes training a first model to perform a natural language processing task to form a plurality of trained layers; generating a second model by replacing at least one of the plurality of trained layers in the first model with an adapter and a residual connector; training the second model to perform a security classification task to provide a trained second model; and provisioning the trained second model in a system to perform the security classification task.

The method may include using the trained second model in the system to classify malicious communications. In one aspect, at least some of the trained layers from the first model are not modified during training of the second model. Training the second model may include modifying parameters in the adapter. The security classification task may include extracting words from a body and text of an email communication; tokenizing one or more words into sub-word tokens; and providing the sub-word tokens as input to an embedding layer of the second model. Training the second model to perform the security classification task may include training the second model using labeled email data. The method may include providing message header features of an email communication to the trained second model including one or more of: a first indication of whether a first domain of a sender matches a second domain of a receiver; a second indication of whether the first domain of the sender matches a reply-to address; a first number of recipients in a ‘To’ field; and a second number of recipients in a ‘CC’ field.

In another aspect, there is disclosed herein a system including a security classifier executing on a threat management resource of an enterprise network, the security classifier performing a classification task. The security classifier may be generated by performing the steps of: storing a model including a plurality of transformer layers configured to perform a natural language processing task; generating a second model by replacing a subset of the plurality of transform layers in the model with adapters and adding an untrained classifier; and training the second model to perform the classification task. The classification task may include classification of maliciousness of messages. The classification task may also or instead include identification of phishing email messages. The model may include a Bidirectional Encoder Representation from Transformers model.

In one aspect, a multi-layer first machine learning model, such as a neural network, may be trained to perform a natural language task. The natural language task may be, for example, to predict missing words in text. The machine learning model may be trained using natural language as input to perform the natural language task. The first machine learning model may be a compressed model. A subset of trained layers of the trained first machine learning model may be used to create a second machine learning model. The second machine learning model may include the subset of the layers of the first machine learning model. For example, in some implementations, 2, 3, or 4 trained layers from the first machine learning model may be included in the second machine learning model. The selected subset of layers from the first machine learning model may be connected by adapter layers in the second machine learning model. An adapter layer may include, for example, a number of dense layers (e.g., 1 dense layer, 2 dense layers, or 3 dense layers) and one or more non-linear activation units (e.g., Rectified Linear Unit (“Relu”) activation units). The adapter may include a residual connection. An untrained classifier also may be included in the second machine learning model.

The second machine learning model may be trained to perform a security classification task. For example, the security classification task may include classifying communications (e.g., email, text messages, documents, and so on) for security purposes, classifying maliciousness of communications, classifying maliciousness of email, or any other suitable task. In some implementations, training may be performed by providing training data that includes malicious email messages and benign email messages. The second machine learning model may be trained for any suitable security classification task, such as tasks that involves the interpretation of text.

The second machine learning model may be provisioned in a system to perform security classification. The classification of maliciousness provided by the second machine learning model may be used to block messages, to quarantine messages, or to provide alerts about messages. In some implementations, the classification of maliciousness may be used to modify, block, redirect, or delete links or other elements from the message. In other implementations, the classification of maliciousness may be used to identify an attack or a root cause of an attack. The classification may be performed, for example, on a mail server, on a security server, on a message server, or on a client device, for example as part of a security facility or as part of a client application.

In some implementations, at least some of the trained layers from the first model may not be modified during training of the second model. Training the second model may include modifying parameters in adapters, modifying parameters in the adapters and only one trained layer from the first model, and/or modifying parameters in the adapters and only some trained layers.

In some implementations, training and/or classification may include extracting words from a communication, tokenizing words into sub-word tokens, and providing sub-word tokens. The sub-tokens may be provided as input to the first machine learning model and/or the second machine learning model. The sub-word tokens may be provided as input to an embedding layer. Extracting words may include extracting words from the subject and body text of an email communication. Feature vectors may be generated from sub-word tokens using TF-IDF (Term Frequency-Inverse Document Frequency).

In some implementations, training the first model may be performed using natural language text from books, articles, and/or the world wide web. In some implementations, training the second model to perform a security classification may be performed using labeled message data, such as labeled email data.

In some implementations, contextual information, such as message header features also may be provided to the second model. Message header features may include, for example, one or more of: an indication of whether the domain of sender and receiver is the same, an indication of whether the domain of sender and reply-to address is the same, a number of recipients in a To field; and a number of recipients in a CC field. Contextual information also may include any suitable information from or based on message header information, including but not limited to time stamps or time zones of senders, mail servers used, communication paths or reputation data determined (e.g., of sender or recipient addresses or mail servers).

In some implementations, a processor may be configured with a model generated as described herein. The model may be used to perform a security classification task, such as classifying messages for maliciousness.

### BRIEF DESCRIPTION OF THE DRAWINGS

The foregoing and other objects, features, and advantages of the devices, systems, and methods described herein will be apparent from the following description of particular embodiments thereof, as illustrated in the accompanying drawings. The drawings are not necessarily to scale, emphasis instead being placed upon illustrating the principles of the devices, systems, and methods described herein.

FIG. 1 illustrates a block diagram of a security recognition device.

FIG. 2 illustrates a machine learning training engine.

FIG. 3 illustrates machine learning models.

FIG. 4 illustrates a model for classification of malicious messages.

FIG. 5 illustrates a graphical depiction of a portion of an example event graph.

FIG. 6 illustrates a threat management system.

FIG. 7 illustrates an exemplary method for performing a security classification task.

### DETAILED DESCRIPTION

Embodiments will now be described with reference to the accompanying figures. The foregoing may, however, be embodied in many different forms and should not be construed as limited to the illustrated embodiments set forth herein.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately” or the like, when accompanying a numerical value, are to be construed as indicating a deviation as would be appreciated by one of ordinary skill in the art to operate satisfactorily for an intended purpose. Similarly, words of approximation such as “approximately” or “substantially” when used in reference to physical characteristics, should be understood to contemplate a range of deviations that would be appreciated by one of ordinary skill in the art to operate satisfactorily for a corresponding use, function, purpose, or the like. Ranges of values and/or numeric values are provided herein as examples only, and do not constitute a limitation on the scope of the described embodiments. Where ranges of values are provided, they are also intended to include each value within the range as if set forth individually, unless expressly stated to the contrary. The use of any and all examples, or exemplary language (“e.g.,” “such as,” or the like) provided herein, is intended merely to better illuminate the embodiments and does not pose a limitation on the scope of the embodiments. No language in the specification should be construed as indicating any unclaimed element as essential to the practice of the embodiments.

In the following description, it is understood that terms such as “first,” “second,” “top,” “bottom,” “up,” “down,” and the like, are words of convenience and are not to be construed as limiting terms.

It should also be understood that endpoints, devices, compute instances, or the like that are referred to as “within” an enterprise network may also be “associated with” the enterprise network, e.g., where such assets are outside an enterprise gateway but nonetheless managed by or in communication with a threat management facility or other centralized security platform for the enterprise network. Thus, any description referring to an asset within the enterprise network should be understood to contemplate a similar asset associated with the enterprise network regardless of location in a network environment unless a different meaning is explicitly provided or otherwise clear from the context.

In some implementations, a machine learning model, such as a neural network or other suitable model, may be trained for a security recognition task, such as determining maliciousness of a message. For example, a malicious message may be a phishing attempt, a message that is not from the sender that it appears to be from and that is intended to entice a user to take an action such as clicking on a link or downloading software.

Security recognition tasks may include but are not limited to the recognition of maliciousness, a security threat, suspiciousness, or any other relevant analysis result. The object of recognition tasks may be, for example, text files, text messages, email messages, social network posts, web site posts, documents, text streams, message streams, or any other suitable analysis object. Recognition tasks may be applied, for example, through parsing of language or other features of text. In addition to features of an object of analysis, such as text features, context information also may be used in a security recognition task. In various implementations, contextual information may include message information, such as message header information, sender or receiver addresses, sender or receiver domains, reputations associated with a sender or receiver, profile information associated with a sender or receiver, time zone information, timestamp information, transmission path information, attachment file size, attachment information, domain reputation information, universal resource locators (URLs), fonts or other message content context information, or any other suitable contextual information. In some implementations, the contextual information is email message header information. The contextual information may be used in combination with the file content information to improve the performance of the recognition task.

In an exemplary implementation, analysis objects may be email messages, and the training data may include email messages that have been labeled as malicious or benign, for example with a probability of maliciousness. Training data also may include contextual information for the email messages.

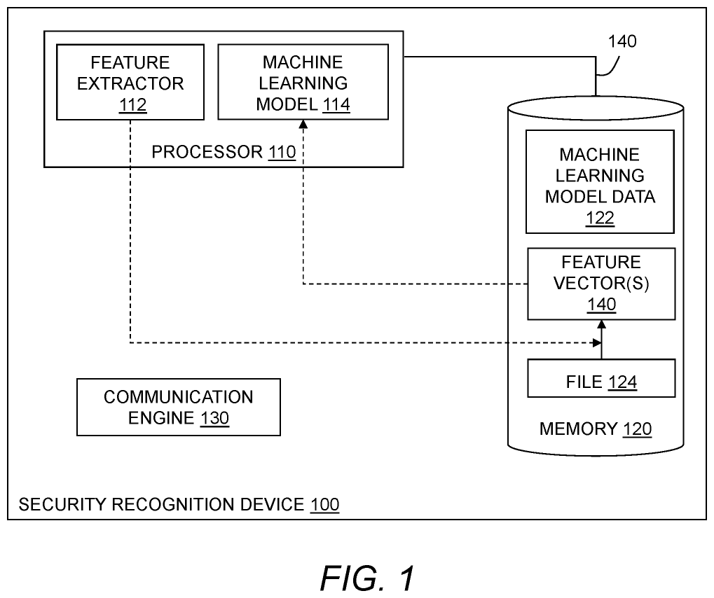

FIG. 1 illustrates a block diagram of a security recognition device 100, according to an embodiment. The security recognition device 100 may be a hardware-based computing device and/or a multimedia device, such as, for example, a compute device, a server, a desktop compute device, a smartphone, a tablet, a laptop and/or the like. The security recognition device 100 may be a compute instance. The security recognition device 100 may include a processor 110, a memory 120 and a communication engine 130.

The processor 110 may be, for example, a hardware based integrated circuit (IC) or any other suitable processing device configured to run and/or execute a set of instructions or code. For example, the processor 110 may be a general purpose processor, a central processing unit (CPU), an accelerated processing unit (APU), an application specific integrated circuit (ASIC), a field programmable gate array (FPGA), a programmable logic array (PLA), a complex programmable logic device (CPLD), a programmable logic controller (PLC) and/or the like. The processor 110 may be operatively coupled to the memory 120 through a system bus 140 (for example, address bus, data bus and/or control bus). While depicted as a single structural element in FIG. 1, it will be understood that the processor 110 may also include any number of associated, peripheral or integrated components and processing circuitry such as caches, input/output interfaces and devices, clocks, memory, and so forth. The processor 110 may also or instead include a virtual machine executing on a virtual computing platform or the like.

The processor 110 may include a feature extractor 112, and a machine learning model 114. Each of the feature extractor 112 and the machine learning model 114 may be software stored in memory 120 and executed by processor 110 (e.g., code to cause the processor 110 to execute the feature extractor 112 and the machine learning model 114 may be stored in the memory 120) and/or a hardware-based device such as, for example, an ASIC, an FPGA, a CPLD, a PLA, a PLC and/or the like.

The feature extractor 112 may be configured to receive an analysis object (e.g., one or more of a file, a text stream, a message, etc.) as an input and output one or more feature vectors associated with the analysis object. In other words, the feature extractor 112 may extract features from the analysis object and form a feature vector including indications of these features. For example, in some exemplary implementations in which the analysis object is a file, text stream, or message the feature extractor 112 may identify words or characteristics of text in a file (for example, message headers, strings, sub-strings, elements, tags and/or the like). A representation of these features may be used to define a feature vector. For example, in some implementations, the feature extractor 112 may identify features of text by selecting words using a predefined vocabulary from text fields (e.g., for a message, subject and plain body text), and generating uni-gram and bi-gram tokens from the selected words. Positional weights may be assigned to tokens to encode positional information, and one or more transformations may be applied to the weights to add non-linearity, e.g., log(w), exp(w), or w².

In some implementations, hash functions may be used as transformation functions and/or to identify a position and/or bucket in the feature vector and a value at that position and/or bucket in the feature vector may be incremented each time a hash value for a feature identifies that position and/or bucket. As another example, in other implementations, a value associated with that feature may be included in the feature vector at that position and/or bucket. In some instances, the positions and/or buckets to which each feature can potentially hash may be determined based on the length and/or size of that feature. For example, strings having a length within a first range can potentially hash to a first set of positions and/or buckets while strings having a length within a second range can potentially hash to a second set of positions and/or buckets. The resulting feature vector may be indicative of the features of the structured file.

As an example, the feature extractor 112 may receive a message and identify text features within that message (e.g., strings, substrings, tokens, etc.). The feature extractor 112 may then provide each feature as an input to a transformation function to generate a value for that feature. The feature extractor 112 may use the values to form a feature vector representative of and/or indicative of the text features of the message. Alternatively, the feature extractor 112 may also receive a HTML, file, an XML file, or a document file, and identify features within that file. The feature vector may be provided as an input to the machine learning model 114.

Likewise, the feature extractor 112 may receive contextual information for an analysis object, such as information associated with a message that is not the message content. This may include, as examples not intended to be limiting, one or more of an indication of whether the domain of sender and receiver is the same, an indication of whether the domain of sender and reply-to address is the same, a number of recipients in an address field, such as a “To” field and/or a “CC” field, a reputation of an address or a domain name associated with an address, transmission information, date and time stamps associated with transmission, time zones, servers used for transmissions, and/or reputations of servers associated with transmission. The feature extractor may perform specified operations on the contextual information, to normalize or reduce it, or to emphasize certain features of the contextual information. For example, the feature extractor may use hash functions or transformation functions on the contextual information. In some implementations, the resulting contextual information may be provided as an input to the machine learning model 114 after converting addresses into numeric vectors with a fixed length. In some implementations, this may be accomplished with a lookup table keyed on each character with a numeric value (between 0 to character set size) representing the character. This may be implemented, for example, as a Python dictionary. This transformation enables addresses to be trimmed to a fixed size.

The machine learning model 114 may be any suitable type of machine learning model such as, for example, a neural network, a decision tree model, a gradient boosted tree model, a random forest model, a deep neural network, or other suitable model. The machine learning model 114 may be configured to receive a feature vector associated with an analysis object, and context information associated with the analysis object, and output an analysis result, such as a score indicating whether the analysis object is, for example, potentially malicious. The machine learning model may then provide an output indicating a threat classification. The threat classification may indicate an evaluation of the likelihood that the analysis object is a threat. For example, the threat classification may classify an analysis object into different categories such as, for example, benign, potentially malicious, malicious, type of malicious content/activity, class of malicious content/activity, attack family, or another suitable threat classification. The threat classification may then provide an output within a range (for example between 0 and 10, between 0 and 1, between 0 and 4) that indicates a probability of maliciousness.

The memory 120 of the security recognition device 100 may be, for example, a random access memory (RAM), a memory buffer, a hard drive, a read-only memory (ROM), an erasable programmable read-only memory (EPROM), and/or the like. The memory 120 may store, for example, one or more software modules and/or code that can include instructions to cause the processor 110 to perform one or more processes, functions, and/or the like (e.g., the feature extractor 112 and the machine learning model 114). In some implementations, the memory 120 may be a portable memory (for example, a flash drive, a portable hard disk, and/or the like) that may be operatively coupled to the processor 110. In other instances, the memory may be remotely operatively coupled with the security recognition device. For example, a remote database server may be operatively coupled to the security recognition device.

The memory 120 may store machine learning model data 122 and an analysis object, shown here as an example as file 124. The machine learning model data 122 may include data generated by the machine learning model 114 during processing of the file 124. The machine learning model data 122 may also include data used by the machine learning model 114 to process and/or analyze an analysis object (for examples, weights associated with the machine learning model, decision points associated with the machine learning model, and/or other information related to the machine learning model).

The analysis object, shown as file 124, may be a text file. The file 124 may be or may include an email message, a representation of a text stream, a document, a text message, a social media post, a web site post, and/or another suitable analysis object. For example, in various implementations, the file may be at least one of a Hypertext Markup Language (HTML) file(s), a JavaScript file(s), an Extensible Markup Language (XML) file, a Hypertext Preprocessor (PHP) file(s), Microsoft® office documents (for example, Word®, Excel®, PowerPoint®, and/or the like), a uniform resource locator (URL), Android Package Kit (APK) files, Portable Document Format (PDF) files, any other files having defined structure, and/or the like. The file 124 may include or can reference at least one of software code, a webpage(s), a data file(s), a model file(s), a source file(s), a script(s), a process(es), a binary executable file(s), data and/or a table(s) in a database system, a development deliverable(s), an active content(s), a word-processing document(s), an e-mail message(s), a text message(s), data associated with a device or an entity (e.g., a network-connected compute device and/or computer system, a server, a smartphone, a tablet a laptop, a multimedia device, etc.), and/or the like. In some instances, the file 124 may be analyzed by the processor 110 of the security recognition device 100 to identify whether the file is malicious, as described in further detail herein.

In some implementations, the analysis object may be, for example, a network stream or a text stream. A representation of the network stream or text stream may be stored in the memory 120. A representation of the network stream or text stream may be included in the file 124. The file 124 may include the output of one or more network sensors recording network traffic that includes a text stream. For example, a text stream may be extracted from network traffic. The file 124 may include data extracted from a data lake of sensor data.

The communication engine 130 may be a hardware device operatively coupled to the processor 110 and memory 120 and/or software stored in the memory 120 executed by the processor 110. The communication engine 130 may be, for example, a network interface card (NIC), a Wi-Fi™ module, a Bluetooth® module and/or any other suitable wired and/or wireless communication device. Furthermore, the communication engine 130 may include a switch, a router, a hub and/or any other network device. The communication engine 130 may be configured to connect the security recognition device 100 to a communication network. For example, the communication engine 130 may be configured to connect to a communication network such as the Internet, an intranet, a local area network (LAN), a wide area network (WAN), a metropolitan area network (MAN), a worldwide interoperability for microwave access network (WiMAX®), an optical fiber (or fiber optic)-based network, a Bluetooth® network, a virtual network, and/or any combination thereof.

In some instances, the communication engine 130 may facilitate receiving and/or transmitting a structured file through a communication network. In some instances, a received file may be processed by the processor 110 and/or stored in the memory 120.

In use, the security recognition device 100 may be configured to receive an analysis object such as a file 124 from a communication network (not shown in FIG. 1) via the communication engine 130 and/or via any other suitable method (e.g., via a removable memory device). The feature extractor 112 included in the processor 110 may be configured to receive the file 124 from the communication engine 130 and extract a set of features from the file 124 to define a feature vector 140. This feature vector 140 and/or the set of features may be stored in the memory 120. The feature extractor 112 also may determine contextual information for the file. The contextual information may include, for example, information in the file 124 in addition to message content. The contextual information may also include, for example, information about the file that is stored, for example, in a database (not shown) or in another file in the memory 120, or that is derived from such information. The machine learning model 114 may retrieve the stored set of features and the contextual information from the memory 120 and analyze the feature vector 140 and the contextual information. Based on the analysis, the machine learning model 114 may determine whether the structured file 124 is malicious (e.g., if a message is intended to be a phishing lure) by outputting a maliciousness classification. The processor 110 may then store the maliciousness classification of the file 124 in the memory 120.

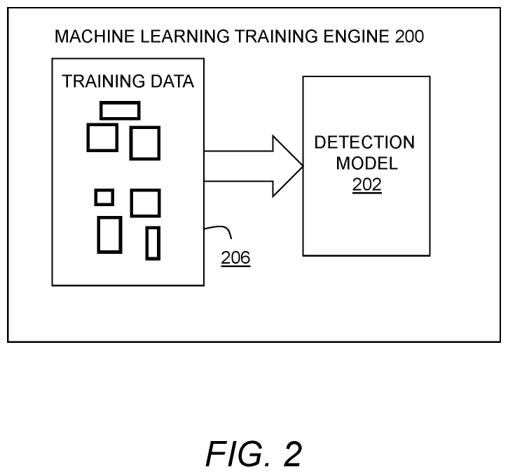

FIG. 2 illustrates a machine learning training engine. An exemplary machine learning training engine 200 may include a detection model 202 and training data 206. Training data 206 may include data used to train a detection model 202. The detection model 202 may be trained to perform security recognition tasks. In some instances, the training data 206 may include multiple sets of data. Each set of data may contain at least one set of input information and an associated desired output value or label, and typically includes a large amount of data and/or number of sets of data. The input information may include analysis objects and context information for the analysis objects. In some implementations, the training data 206 may include input files pre-categorized into categories such as, for example, malicious messages and benign messages. In some implementations, the training data 206 may include input messages with associated threat scores. In some implementations, the training data 206 may include contextual data, such as address information and/or reputation information. In some implementations, the training data 206 may include feature vectors derived from files or other source data, along with context information for the source data. In some implementations, the training data 206 may include files, context information for the files, and threat scores for files.

In some implementations, the context information for an analysis object includes context information from multiple, different observations of that analysis object. For example, for a message, context information may include up to five address context results after normalization, with each result obtained from a different observation of the message.

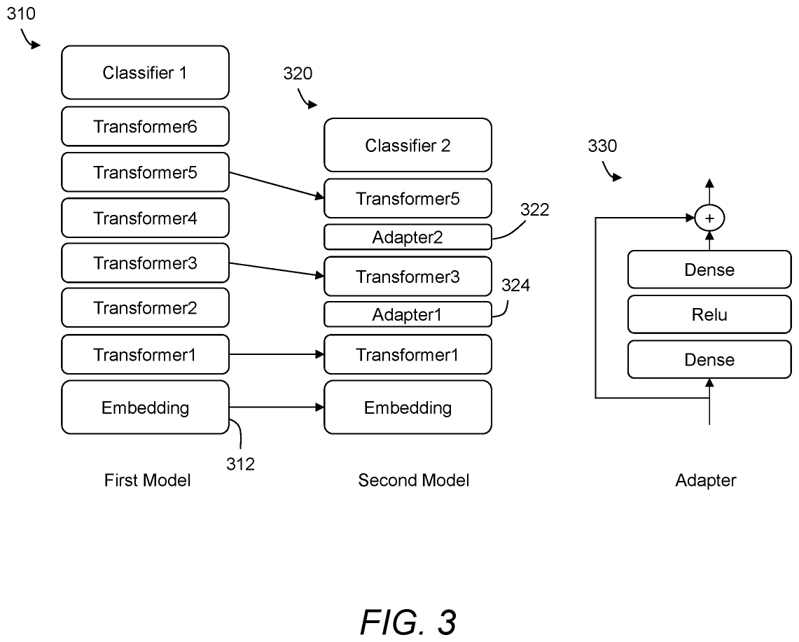

FIG. 3 illustrates machine learning models. A first machine model 310 may be trained to perform a natural language task. In some implementations, the natural language task may include predicting words in text, translating words in text, checking grammar in text, or any other suitable task. The first machine learning model 310 may be trained using natural language as input to perform the natural language task. A large corpus of natural language, such as books, pages on the world wide web, archives of email messages, and published text documents, may be used to train the first machine learning model 310 on the natural language task. In general, it is preferred that training the first machine learning model 310 on the natural language task will train the layers of the first machine learning model 310 to interpret aspects of natural language in order to perform the natural language task.

In some implementations, the first machine learning model 310 may be based on a neural network construct referred to as a transformer block, also referred to herein as a transformer layer. Transformer blocks may be viewed as attentional mechanisms that output context vectors for each word that depend on the context for that word (see Vaswani et al., Attention is all you need, arXiv preprint arXiv:1706.03762, 2017, which is incorporated by reference in its entirety herein). Transformer blocks may be used in self-attention language models such as BERT (see Devlin et al., Bert: Pre-training of deep bidirectional transformers for language understanding, arXiv preprint arXiv:1810.04805, 2018, which is incorporated by reference in its entirety herein) and OpenAI's GPT, which uses a differing transformer block-based approach (see Radford, Alec et al., Language models are unsupervised multitask learners. (2019)), which is incorporated by reference in its entirety herein). GPT uses a standard language modelling objective to maximize the likelihood of a next token for a given sentence. The model may be comprised of multiple Transformer blocks which apply a multi-headed self-attention operation over the input text. After training the model by predicting the next work in a sentence, the model may be further trained by both optimizing a supervised objective and a language modelling objective. While GPT may be fine-tuned for classification tasks, a preferable application for the autoregressive language model is text generation. In our preliminary experiments, both GPT and BERT models obtained comparable performance when they contain a same number of Transformer blocks.

BERT and GPT have been deployed in various Natural Language Processing (NLP) tasks including sentiment classification, machine reading comprehension and natural language inference. They use semi-supervised learning, which makes use of both unsupervised and supervised approaches and efficient self-attention architecture. For example, they may use pre-training with a large unlabeled dataset and fine-tuning with a small, labelled dataset. They may have self-attention layers, which consist of Transformer blocks. In some implementations, a BERT model may be trained to predict masked words in a sentence with large-scale datasets. The model may also learn to correctly predict next sentence prediction.

A feature extractor may provide feature vectors representing natural language text to the embedding 312 of the first machine learning model 310. The embedding layer may map the input from the input space to a continuous fixed-dimensional vector embedding space.

When processing an NLP task, the first model 310 may preprocess raw text and convert the text as a sequence of word tokens. The NLP may use a pre-defined vocabulary for tokenization as in traditional models, and/or sub-word tokenizers such as those employed in BERT and GPT. In some implementations, a BERT tokenizer may divide a complex word into simple sub-words in order to maintain a small vocabulary of approximately 30,522 tokens for English models and approximately 119,547 tokens for Multilingual models. The sub-word tokenizer can mitigate out-of-vocabulary problems when unknown words are tokenized into sub-words. Token inputs may be represented as token embeddings and the position information of tokens may be represented as positional embeddings.

In some implementations, in the input embeddings for email text data, there may be two special tokens: CLS as the first token and SEP as the last token for every text input. BERT-based models may be configured to handle up to a maximum sequence length of 512. Text may be truncated from the beginning of tokens when the length of tokens is larger than the limit. The hidden state for CLS token from the last Transformer block may then be fed into the final classification layer.

In some implementations, when subject and body text are given, concatenated BERT tokens may be provided as the input to a token embeddings block and the position information of tokens is additionally fed into a position embeddings block. The two embeddings may be jointly learned during training and summed vectors may be fed to the next Transformer layers.

For files or data streams that include information in addition to plain text, the plain text may be efficiently extracted. For example, when an email contains a HTML body without a plain text body, the plain text may be extracted using an HTML parser and simple regular expressions. This HTML parsing may reduce the risk of HTML obfuscation attacks which insert random HTML tags between words by identifying human-readable message text within or among non-substantive HTML expressions.

BERT models can be computationally expensive and memory intensive. Model compression methods may be used to reduce the parameters of models without significantly decreasing the model performance. For example, parameter pruning (see Han et al., Deep compression: Compressing deep neural networks with pruning, trained quantization and Huffman coding, arXiv preprint arXiv:1510.00149, 2015, which is incorporated by reference in its entirety herein) may be used for model compression. Pruning methods remove less important neurons or collections by measuring the importance of neurons. While these methods may result in a smaller sparse network, the speedup of inference time is not guaranteed as many deep learning frameworks do not fully support sparse operations. As another example, knowledge distillation (see Hinton et al., Distilling the knowledge in a neural network, arXiv preprint arXiv:1503.02531, 2015, which is incorporated by reference in its entirety herein) also may be used for model compression. Knowledge distillation methods compress deep networks into shallower ones where a compressed model, a student network, mimics the function learned by a complex model, a teacher network. One of the advantages of knowledge distillation is that any student architecture may be trained with a complex teacher network to provide similar network functions in a more compact computational form. The method may train a student model with a standard classification loss and an additional distillation loss. The distillation loss indicates the output differences between the two models and allows the student to learn and apply rich representations from the larger teacher model.

In some implementations, the first model 310 may be a compressed BERT model. For example, as described in Sanh et al., A distilled version of BERT: smaller, faster, cheaper and lighter, arXiv preprint arXiv:1910.01108, 2019, which is incorporated by reference in its entirety herein, a student network (called DistilBERT) may be trained with a large teacher BERT network and the thinner student model may have comparable performance with its teacher network. In another approach, ALBERT (see Lan et al., ALBERT: A Lite BERT for Self-supervised Learning of Language Representations, arXiv preprint arXiv:1909.11942, 2019, which is incorporated by reference in its entirety herein) reduces the model size by sharing a Transformer block in cross layers. In some implementations, a student network (e.g., DistilBERT) may be trained with a large teacher network (e.g., BERT) in pre-training and a thinner student model can be obtained that has comparable performance with its teacher network. For example, the original natural language processing model may have twelve transformer blocks, and those may be reduced to a student model with the six blocks illustrated in the first model 310 by, for example, removing every other layer and training the compressed model with the remaining blocks. More generally, any number and position of layers may be removed provided the resulting student model can be satisfactorily trained to provide comparable performance for the uses contemplated herein.

A second model 320 may be generated from the first model 310. Elements of the first model 310 may be included in the second model 320, and the second model 320 may then be trained to perform a classification task such as a security classification task for use in malware detection or prevention. This approach may be advantageously employed for detecting phishing or other similar attacks where an initial teacher model trained for natural language processing provides a suitable classification context for attack vectors intended to provoke human responses to a readable message. In the second model 320, a classification header may be added and the whole network may then be jointly optimized with training labels. Since the model parameters are trained in the first model 310 with large-scale data, training the second model 320 with a smaller labelled dataset for two or three epochs has yielded acceptable performance in practice.

As described, the first model 310 may be a pre-trained model that has already been compressed from a standard BERT model. The second model 320 may further compress the first model by reducing the number of transformer layers, for example, by a factor of two or more. A subset of the transformer blocks in the first model 310 may be included in the second model 320, and missing transformer blocks may be replaced with adapters (e.g., a first adapter 322 and a second adapter 324). Each adapter may be similar in approach to those described in Houlsby et al., Parameter-Efficient Transfer Learning for NLP, arXiv:1902.00751, 2019, which is incorporated by reference in its entirety herein. Adapters may serve as efficient alternatives to storing large, costly Transformer-based models by allowing a learning model, such as the first model 310, to adapt to multiple related tasks without fine-tuning the entire model for each task. The parameter size of adapters may be far smaller than that of transformer blocks, with a parameter size that may be less than 10% of that of transformer blocks. Thus, the adapters may reduce learning costs and model size for downstream tasks. Replacing some of the transformer blocks with simple adapters may also improve inference speed, and allow adapter and transformer blocks to be jointly adapted to a new task.

The second model 320 may include a subset of the transformer blocks of the first model 310 (e.g., Transformer1, Transformer3, Transformer 5). For example, removing every other transformer block (e.g., the even-numbered or odd-numbered transformers) can reduce the size and complexity of Transformer-based models by a factor of two. Knowledge distillation may be used to further compress the second model 320.

In the exemplary implementation of FIG. 3, Transformer1, Transformer3, Transformer5, and the embedding layer may be initialized from the parameters from the first model 310. The classifier (Classifier2) for the second model 320 may be randomly initialized. The missing transformer blocks (Transformer2, Transformer4, Transformer6) may be replaced with simple randomly initialized, trainable adapter blocks.

An adapter block 330 may be implemented as a fully connected Dense unit, a Relu activation unit and a second Dense unit, with a residual connection. The Dense units may have the same dimensionality with transformers. However, the architecture of the adapter block 330 in FIG. 3 is provided by way of example only, and it will be understood that many other configurations or layouts for the adapter block 330 are also or instead possible. For example, while a Relu activation layer is shown, any suitable nonlinearity layer may be used, such as a sigmoid layer, a hyperbolic tangent activation (“TanH”) layer, and a LeakyRelu layer. The layout of the adapter blocks 330 in the second model 320 may be customized as well. Adapters may be replaced in a modular fashion with new arrangements and combination. For example, the second model 320 may have several adapter blocks in parallel. The second model 320 may also have multiple adapter blocks feeding directly to one another in series between two transformer blocks.

Simply removing half of the transformer blocks and replacing them with trainable adapter blocks may be sufficient to surpass the already-high performance of the full model, despite the presumed interdependence between successive blocks. Depending on the model and the task, it may be possible to further reduce the number of transformer blocks, such as with further knowledge distillation.

The second model 320 may be trained for a security recognition task (e.g., phishing detection) using a binary cross entropy loss function. The loss L is defined by given the output of our model f(x; θ) for input x and label y∈{0,1} and model parameter θ.

L(x,y;θ)=−y log(f(x;θ))+(1−y)log(1−f(x;θ))

This may be solved for 6, the optimal set of parameters that minimize the loss over the dataset:

$$\hat{θ} = arg min {\sum }_{i = 1}^{n} L ( {x}^{( i )} , {y}^{( i )} ; θ ) \qquad$$

Here, N is the number of samples in the dataset, and y⁽ⁱ⁾ and x⁽ⁱ⁾ are the label and the feature vector of the i^{th} training sample respectively.

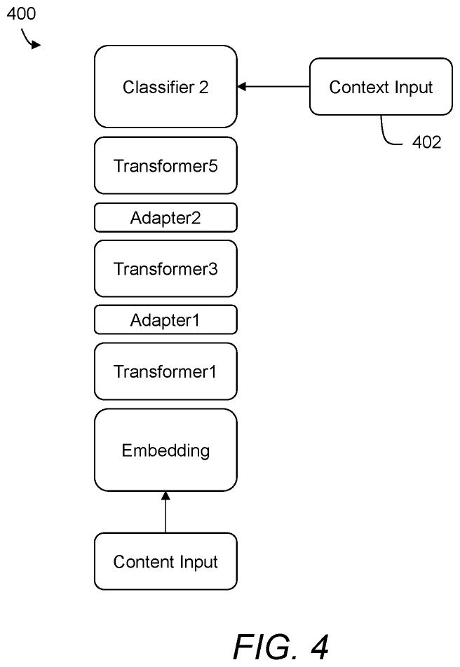

FIG. 4 illustrates a model for classification of malicious messages. An implementation of a second model 400 (such as the second model 320 of FIG. 3) may use context information such as the context input 402 shown in FIG. 4. The context information may be provided as input to the classifier during training of the second model 400. For example, context information from header fields may be provided as context input 402. Context information may also or instead include an indication of internal communication, such as an indication of whether the sender and receiver of the communication have the same domain. Context information may also or instead include an indication of external communication, such as an indication that the sender's domain and receiver's domain are different. The context information may also or instead include a number of recipients of the communication, such as the number of recipients listed in the “To” address field and the number of recipients listed in the “CC” address field. To accommodate the context and the content features, the second model 400 may receive two inputs. Content features may be fed into the embedding layer and/or fed directly into the classification layer. There may be additional dense units after the last transformer layer where the context features may be provided as context input 402 and combined with the transformer layers' rich text representation. The classifier (Classifier2) head of the second model 400 may then return sigmoid outputs which indicate the maliciousness of input emails.

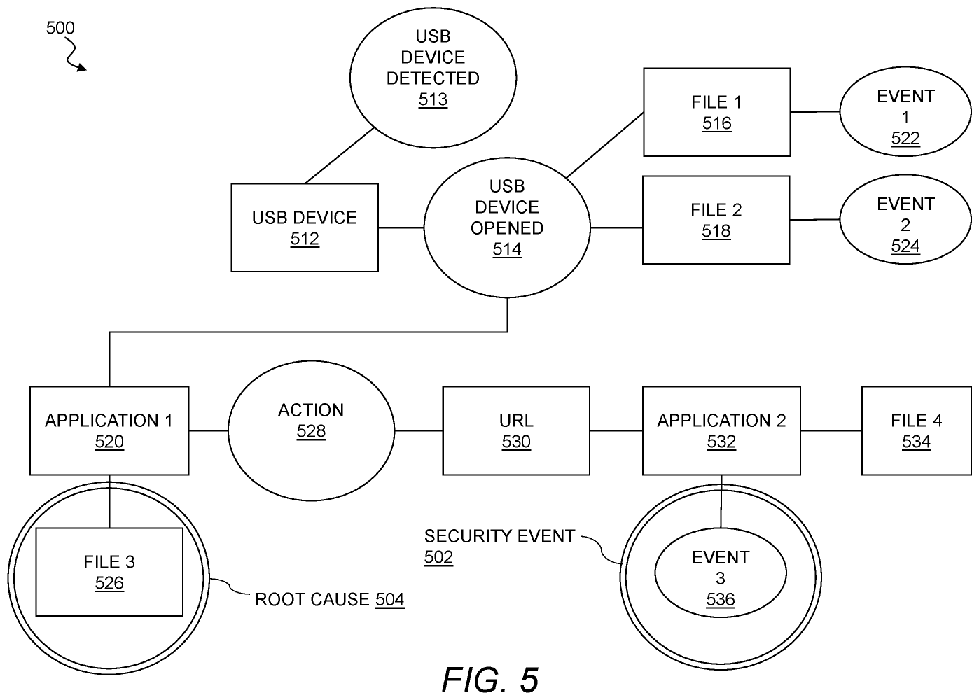

FIG. 5 illustrates a graphical depiction of a portion of an example event graph, according to an embodiment. A graphical depiction of a portion of an example event graph 500 may be used in some embodiments to record the results of a machine learning model (e.g., machine learning model 112 (FIG. 1)) and other information about a target device, for example, an endpoint. The event graph 500 may include a sequence of computing objects causally related by a number of events, and which provide a description of computing activity on one or more endpoints. The event graph 500 may be generated as a compute instance operates, or upon the occurrence of an event, for example, when a security event 502 is detected on an endpoint, and may be based on a data log or similar records obtained by an event data recorder during operation of the endpoint. The event graph 500 may be used to determine a root cause 504 of the security event 502 as generally described above.

The event graph 500 may also or instead be continuously, periodically and/or intermittently generated to serve as, or be a part of, the data log obtained by the data recorder. In any case, an event graph 500, or a portion of an event graph 500 in a window of time before or around the time of a security event, may be obtained and analyzed after a security event 502 occurs to determine its root cause 504. The event graph 500 depicted in FIG. 5 is provided by way of example only, and it will be understood that many other forms and contents for event graphs 500 are also or instead possible. It also will be understood that the figure illustrates a graphical depiction of an event graph 500, which may be stored in a database or other suitable data structure. Generation or presentation of the event graph may be directed or configured using information about a type of malware determined, as described herein.

By way of example, the event graph 500 depicted in the figure may begin with an application 520 that is running on an endpoint. The application may be, for example, an email client application. The application 520 may access a file 526, which may be, for example, an email message. The email message is represented in a file 526 although it may be a message stream, an entry in an email database, and so on. The file 526 may be associated with a first event 536, for example, by a determination that the file 526 is a message that is potentially or actually malicious. A determination that the message is malicious may be made with a classifier as described herein. A second file 534 may be associated with the event 536, for example, that may be potentially or actually malicious. In this example, the user of the email application 520 may be directed to download file 4 534 through use of a second application 532, which may be, for example, a web browser that is directed by the URL 530 in the message to a malicious web site.

The first application 520 may access the email message in file 3 526 on the endpoint. The application 520 may also perform one or more actions, such as accessing a USB device 512. In reaction to the malicious message in file 3 526, the user may cause application 520 to run a second application 532 on the endpoint, which in turn may access one or more files (e.g., file 4 534).

In the example provided, the detected security event 502 may include an action associated with the second application 532, e.g., accessing file 4 534. By way of example, the URL 530 may be a malicious URL that is associated with or delivers malware. The URL 530 may also or instead include a new network address that is not associated with malware. The URL 530 may have a determined reputation or an unknown reputation. The URL 530 may involve the downloading of file 4 534. When file 4 534 is downloaded, the techniques described above may be applied, for example at a network gateway or at an endpoint, and a determination made that file 4 534 is potentially malicious and a type of malware determined as described herein.

In response to detecting the security event 502, the event graph 500 may be traversed in a reverse order from a computing object associated with the security event 502 based on the sequence of events included in the event graph 500. For example, traversing backward from the action 532 may lead to at least the first application 520. As part of a root cause analysis, one or more cause identification rules may be applied to one or more of the preceding computing objects having a causal relationship with the detected security event 502, or to each computing object having a causal relationship to another computing object in the sequence of events preceding the detected security event 502. In an aspect, the one or more cause identification rules may be applied to computing objects preceding the detected security event 502 until a cause of the security event 502 is identified.

In the example shown in FIG. 5, the message in file 3 526 may be identified as the root cause 504 of the security event 502. In other words, the malicious message in file 3 526 may have initiated the security event 502 (the action 528 of accessing the potentially malicious or otherwise unwanted URL 530, and the related access of file 4 534). Events that are relevant, for example, events that are displayed to a user or to an administrator may be based at least in part on the type of malware that is determined as described herein. The classification of the message in file 3 526 may be used to help identify file 3 526 as a root cause 504.

The event graph 500 may be traversed going forward from one or more of the root cause 504 or the security event 502 to identify one or more other computing objects affected by the root cause 504 or the security event 502. For example, file 1 516 and file 2 518 potentially may be corrupted. Similarly, any related actions performed after the security event 502 such as any actions performed by the second application 532 may be corrupted. Further testing or remediation techniques may be applied to any of the computing objects affected by the root cause 504 or the security event 502.

The event graph 500 may include one or more computing objects or events that are not located on a path between the security event 502 and the root cause 504. These computing objects or events may be filtered or ‘pruned’ from the event graph 500 when performing a root cause analysis or an analysis to identify other computing objects affected by the root cause 504 or the security event 502.

It will be appreciated that the event graph 500 depicted in FIG. 5 is an abstracted, simplified version of actual nodes and events on an endpoint for demonstration. Numerous other nodes and edges can be present in a working computing environment. Thus, it will be appreciated that the event graph 500 depicted in the drawing is intended to serve as an illustrative example only, and not to express or imply a particular level of abstraction that is necessary or useful for root cause identification as contemplated herein. It will also be understood that the event graph 500 may be used in other ways. For example, where an initial security event 502 is a classification of malware for an electronic communication, e.g., using the classification techniques described herein, an event graph 500 may be created tracing causally related downstream events and computer objects. This event graph 500 may be used to focus further investigation and remediation based on the causal relationship with the electronic mail communication that was classified as a security risk.

The event graph 500 may be created or analyzed using rules that define one or more relationships between events and computing objects. For example, the C Language Integrated Production System (CLIPS) is a public domain software tool intended for building expert systems, and may be suitably adapted for analysis of a graph such as the event graph 500 to identify patterns and otherwise apply rules for analysis thereof. While other tools and programming environments may also or instead be employed, CLIPS can support a forward and reverse chaining inference engine suitable for a large amount of input data with a relatively small set of inference rules. Using CLIPS, a feed of new data can trigger a new inference, which may be suitable for dynamic solutions to root cause investigations.

An event graph such as the event graph 500 shown in FIG. 5 may include any number of nodes and edges, where computing objects are represented by nodes and events are represented by edges that mark the causal or otherwise directional relationships between computing objects such as data flows, control flows, network flows and so forth. While processes or files can be represented as nodes in such a graph, any other computing object such as an IP address, a registry key, a domain name, a uniform resource locator, a command line input or other object may also or instead be designated to be represented as a node in an event graph as contemplated herein. Similarly, while an edge may represent an IP connection, a file read, a file write, a process invocation (parent, child, etc.), a process path, a thread injection, a registry write, a domain name service query, a uniform resource locator access and so forth other edges may be designated and/or represent other events. As described above, when a security event is detected, the source of the security event may serve as a starting point within the event graph 500, which may then be traversed backward to identify a root cause using any number of suitable cause identification rules. The event graph 500 may then usefully be traversed forward from that root cause to identify other computing objects that are potentially tainted by the root cause so that a more complete remediation can be performed.

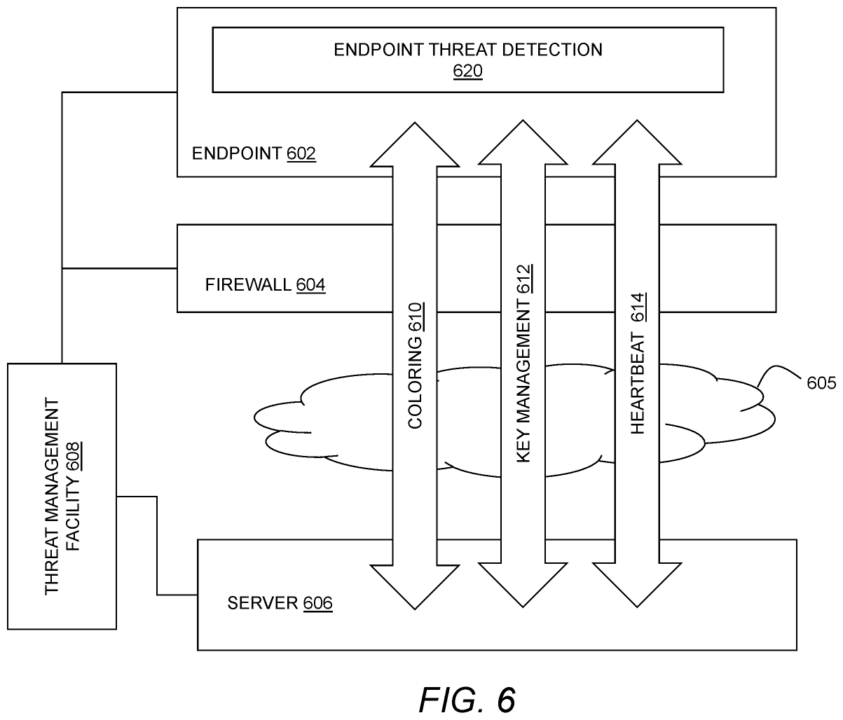

FIG. 6 illustrates a threat management system. In general, the system 600 may include an endpoint 602, a firewall 604, a server 606 and a threat management facility 608, coupled to one another directly or indirectly through a data network 605, as generally described above. Each of the entities depicted in FIG. 6 may, for example, be implemented on one or more computing devices, network devices, mobile devices, etc. A number of systems may be distributed across these various components to support threat detection, such as a coloring system 610, a key management system 612 and a heartbeat system 614 (or otherwise an endpoint health system), each of which may include software components executing on any of the foregoing system components (e.g., processors similar to processor 110 shown and described with respect to FIG. 1), and each of which may communicate with the threat management facility 608 and an endpoint threat detection agent 620 executing on the endpoint 602 (e.g., executing on a processor of the endpoint 602) to support improved threat detection and remediation.

The coloring system 610 may be used to label or ‘color’ software objects for improved tracking and detection of potentially harmful activity. The coloring system 610 may, for example, label files, messages, executables, processes, network communications, data sources and so forth with any suitable label. A variety of techniques may be used to select static and/or dynamic labels for any of these various software objects, and to manage the mechanics of applying and propagating coloring information as appropriate. For example, a process may inherit a color from an application that launches the process. Similarly, a file may inherit a color from a process when it is created or opened by a process, and/or a process may inherit a color from a file that the process has opened. More generally, any type of labeling, as well as rules for propagating, inheriting, changing, or otherwise manipulating such labels, may be used by the coloring system 610 as contemplated herein. The assignment of colors may be an event that is recorded in the event graph 500 (FIG. 5). The assignment of colors may be or may be based on a determination of a type of malware, as described herein. For example, different colors may be assigned based on whether a file has been determined as a rootkit, a trojan, an adware, a worm, or a keylogger. In other implementations, different colors may be assigned based on the probability that a file is a type of a malware.

The key management system 612 may support management of keys for the endpoint 602 in order to selectively permit or prevent access to content on the endpoint 602 on a file-specific basis, a process-specific basis, an application-specific basis, a user-specific basis, or any other suitable basis in order to prevent data leakage, and in order to support more fine-grained and immediate control over access to content on the endpoint 602 when a security compromise is detected. Thus, for example, if a particular process executing on the endpoint is compromised, or potentially compromised or otherwise under suspicion, access by that process may be blocked (e.g., with access to keys revoked) in order to prevent, e.g., data leakage or other malicious activity. Depending on the policies in place, the key management system 612 may be triggered, for example, by output from a machine learning model (e.g., machine learning model 112 of FIG. 1, by a combination of the output of the machine learning model with other information, by the coloring system, by a detection based on the event graph 500 and/or by any other suitable trigger). A policy may be based on a determination of maliciousness as described herein. For example, there may be first policy based on a determination that a message is malicious (e.g., a phishing attack), and a second policy based on a determination that an action was taken based on that message.

The heartbeat system 614 may be used to provide periodic or aperiodic information from the endpoint 602 or other system components about system health, security, status, and/or so forth. The heartbeat system 614 or otherwise an endpoint health system may thus in general include a health status report system for the endpoint 602. A heartbeat may be encrypted or plaintext, or some combination of these, and may be communicated unidirectionally (e.g., from the endpoint 602 to the threat management facility 608) or bidirectionally (e.g., between the endpoint 602 and the server 606, or any other pair of system components) on any useful schedule. The heartbeat system 614 may be used to communicate an identification of malicious or potentially malicious artifacts and types of malware using the techniques described herein to or from an endpoint and/or a firewall and/or a server and/or a threat management facility. A threat management facility 608 may have a first policy that is based on a determination that an artifact is malicious (e.g., a phishing attack message), and a second policy that is based on a determination that an action has been taken based on the malicious artifact. A determination that a given artifact is malicious may be used to select policies or to take actions as appropriate (e.g., as has been configured) based on rules for that type of artifact.

In general, these various monitoring and management systems may cooperate to provide improved threat detection and response. For example, the coloring system 610 may be used when a particular artifact is identified as malicious or potentially malicious, as described, for example, using the machine learning models described herein. The detection may be recorded as an event in an event graph, for example as described with respect to FIG. 5. A color may be assigned to the artifact (e.g., a malicious email), and the assignment of the color to the file included as an event in an event graph as described with respect to FIG. 5. The color may also be associated with downstream events and computer objects based on the causal association with the artifact. A potential threat may be confirmed based on an interrupted heartbeat from the heartbeat system 614 and/or based on assigned colors or events in the event graph 500. The key management system 612 may then be deployed to revoke access by the process to certain resources (e.g., keys or file) so that no further files can be opened, deleted, or otherwise modified. More generally, the cooperation of these systems enables a wide variety of reactive measures that can improve detection and remediation of potential threats to an endpoint. Generally, having information about the type of malware that has been identified enables more fine-grained rules and responses, that is, rules and responses may be configured based on the type of malware determined, with the result, for example, that alerts and remedial actions can be taken automatically based on the type of malware determined. Likewise, information can be communicated and recommendations of remedial actions can be made to users or administrators based on the determination of maliciousness.

A server 606, such as an email server, also may use the techniques described herein to identify malicious email messages, and take actions, such as blocking or quarantining the message, or modifying the message to remove links or other actions. For example, the server 606 may deploy a machine learning model and apply the model to classify electronic mail communications (e.g., as security risks). In response to determining that a message is malicious or potentially malicious, the server 606 may provide alerts or messages to administrators or users and/or to the threat management facility 608. The server 606 may determine that a message comes from a particular email source, and take action to block, restrict, or scrutinize further messages from that source.

The endpoint 602 may also or instead deploy a machine learning model in a local agent or other module or endpoint threat detection system 620, where the model may be used to classify electronic mail communications or other communications (e.g., text messages, web chat messages, etc.) as risky or malicious. The endpoint threat detection system 620 may also responsively deploy and suitable local remediations and/or notify the threat management facility 608. The threat management facility 608 may also or instead deploy the machine learning model, and or receive notifications from such a model operating on an endpoint 602 or server 606, and may take any suitable responsive actions to e.g., a risky message such as investigating other messages to the source or examining activity related to the message.

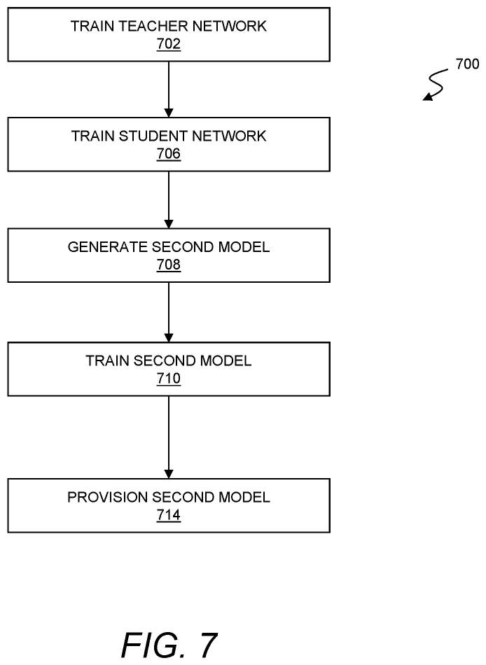

FIG. 7 illustrates an exemplary method for performing a security classification task. In general, machine learning models may be trained for security recognition tasks, such as the classification of malicious messages. In many cases, however, such models derived from natural language processing techniques may become impractically large and inefficient, with millions of parameters and storage sizes measured in gigabytes. As described herein a model for security recognition tasks can be compressed and trained to provide comparable classification of electronic mails or other human-readable messages and communications. While these techniques may advantageously be employed to yield practical deployments of very large natural language processing models trained on very large data sets, the techniques are more generally suited to any large, similarly-structured machine learning models that can be compressed using teacher-student techniques, transformer layer reconfigurations, and so forth.

As shown in step 702, the method 700 may include training a teacher network. For example, this may include training a teacher model including a first plurality of transformer layers to perform a natural language processing task using a large-scale natural language data set. The teacher network may be trained to perform a variety of natural language processing (NLP) tasks, including, but not limited to, next sentence prediction, masked word prediction, speech recognition, text translation, text summarization, information extraction, or any other suitable task. In some embodiments, the teacher network may include a Bidirectional Encoder Representation from Transformers model. The teacher network may have a plurality of transformer layers, with each layer differentially weighing the significance of each part of an input data to provide attentional context to the data.

As shown in step 706, the method 700 may include training a student network to follow the behavior of a teacher network. The student network may initially include a subset of transformer layers in the teacher network. For example, this may include training a student network with a second plurality of transformer layers less than the first plurality of transformer layers (of the teacher network) to reproduce functions of the teacher network in a compressed model, yielding a compressed or distilled version of the teacher network that mimics the learned task of the teacher network. A variety of techniques may be used to compress the teacher network, including, but not limited to, knowledge distillation, pruning, quantization, neural architecture search, or other suitable compression techniques. For example, knowledge distillation may generate the student network by transferring a knowledge set of the teacher network (or an ensemble of teacher networks) into a smaller network. The teacher network may be compressed such that the student network has fewer transformer layers than the teacher network. The teacher network may also, or alternatively, be compressed such that the student network has the same number of transformer layers but with fewer subunits in each transformer layer. In some embodiments, knowledge distillation may be used to train multiple student networks in parallel with the training of the teacher model.

As shown in step 708, the method 700 may include generating a second model by replacing a subset of trained layers in the second plurality of transformer layers of the student network with simplified layers. For example, this may include replacing at least one of the second plurality of transformer layers that had been trained to perform a natural language processing task with an adapter. The adapter may be composed of one or more adapter blocks. An exemplary adapter block may be implemented with a first fully connected Dense layer, an activation unit, and a second Dense unit. A variety of activation functions may be used for the activation unit for scaling inputs to outputs, such as a Relu function, a sigmoid function, a hyperbolic tangent activation function (TanH”), a LeakyRelu function, or any other suitable function. The fully connected Dense layer may have the same dimensionality as the second plurality of transformer layers. While FIG. 3 displays a second model 320 with an exemplary adapter model layout, it will be appreciated that a wide variety of arrangements may be used for the adapter. For example, the adapter may have several adapter blocks in parallel. The adapter may also, or alternatively, have multiple adapter blocks feeding directly to one another in series between two transformer layers. The adapter may have at least one randomly initialized, trainable adapter block interconnecting two of the transformer layers. In some implementations, half of the second plurality of transformer layers may be replaced with adapter blocks.

As shown in step 710, the method 700 may include training the second model to perform a new task such as a security classification task. For example, this may include tuning the second model with a labelled target dataset specific to phishing detection. In one aspect, one or more layers of the second model, such as the embedding and lower level transformer layers (e.g., Transformer1 and Transformer3 in FIG. 4) may be frozen to prevent changes from the student model for those layers, while updating adapters and higher level transformer layers. This may also or instead include adding a new transformer layer or the like specific to the new classification task. Thus, in one aspect a new classification header may be added and the resulting network can be optimized with training labels (e.g., phishing/not-phishing labels, in the example above). In this manner, the distilled model (e.g., the student model with adapters replacing some of the transformer layers) can be directly optimized without requiring the (significantly larger) teacher model. Further, the fine-tuning and the resulting model are significantly more efficient due to the reduced size and complexity, while demonstrably yielding comparable results in the phishing detection task.

Alternatively, the second model may be trained to perform, without the need to generate new models, a variety of additional or alternative security classification tasks, including, but not limited to classifying communications as ransomware, phishing attacks, malware, scams, spam, and so forth, or any other attack vector within communications that can be identified and labeled for a training data set. It will also be understood that the model may also or instead usefully be trained for other classification tasks that leverage the natural language capabilities of the initial teach model, such as explicit or suggestive content, inflammatory remarks, hostile or inappropriate tone, and so forth.

As shown in step 714, the method 700 may include provisioning the second model in an enterprise network to perform the security classification task.

For example, the enterprise network may include one or more endpoints that receive the model and locally deploy the model for use in classifying communications. In another aspect, a threat management facility may deploy the second model (as fine-tuned for a particular classification task). In another aspect, a server or host for the enterprise such as an electronic mail server or other messaging server or communications platform may deploy the model to classify traffic passing through the server.

In operation, the security classification task (and the corresponding training) may include extracting words from a body and text of an email communication, tokenizing one or more words into sub-word tokens, and providing the sub-word tokens as input to an embedding layer of the second model. More generally, although not illustrated in FIG. 7, an initial step to applying the model may include pre-processing input content using any suitable feature extraction tools or the like corresponding to the handling of the training data or otherwise conforming the source data to the training data and/or input requirements of the second model.

Each communication to be classified may also be processed to extract contextual information such as message header features. For example, contextual information may include an indication of whether a domain of a sender matches a domain of a receiver (e.g., whether the communication is internal or external), a second indication of whether the domain of the sender matches a reply-to address for the communication, the number of recipients in a ‘To’ field, the number of recipients in a ‘CC’ field, or other features that might be relevant to the classification task for the model. The second model may then perform the security classification task as generally described herein.

According to the foregoing, there is also disclosed herein a system including a security classifier executing on a threat management resource of an enterprise network, the security classifier performing a classification task. The threat management resource may, for example, include a local security agent executing on an endpoint in the enterprise network, a local or remote (e.g., cloud-based) threat management facility for the enterprise network, a firewall or gateway for the enterprise network, a communications platform for the network (e.g., an email server, instant messaging server, and so forth), or any other resource.

In general, the security classifier, and the security classifier may include a machine learning model such as any of the machine learning models described herein, and may be generated, for example, by performing the steps of: storing a model including a plurality of transformer layers configured to perform a natural language processing task; generating a second model by replacing a subset of the plurality of transform layers in the model with adapters and adding an untrained classifier; and training the second model to perform the classification task.

The classification task may include a classification of maliciousness of messages, an identification of phishing email messages, or any other security classification task or the like. The model and/or the second model may include a Bidirectional Encoder Representation from Transformers model, a distilled or compressed version of such a model, a modified version of such a model or some combination of these. For example, as described above, the second model may replace one or more transformer layers of a model with an adapter, and may add a classification head end to assist in fine-tuning the second model for a new classification task such as security classification of electronic mail communications.

The above systems, devices, methods, processes, and the like may be realized in hardware, software, or any combination of these suitable for a particular application. The hardware may include a general-purpose computer and/or dedicated computing device. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. In another aspect, the methods may be embodied in systems that perform the steps thereof, and may be distributed across devices in a number of ways. At the same time, processing may be distributed across devices such as the various systems described above, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

Embodiments disclosed herein may include computer program products comprising computer-executable code or computer-usable code that, when executing on one or more computing devices, performs any and/or all of the steps thereof. The code may be stored in a non-transitory fashion in a computer memory, which may be a memory from which the program executes (such as random-access memory associated with a processor), or a storage device such as a disk drive, flash memory or any other optical, electromagnetic, magnetic, infrared, or other device or combination of devices. In another aspect, any of the systems and methods described above may be embodied in any suitable transmission or propagation medium carrying computer-executable code and/or any inputs or outputs from same.

It will be appreciated that the devices, systems, and methods described above are set forth by way of example and not of limitation. Absent an explicit indication to the contrary, the disclosed steps may be modified, supplemented, omitted, and/or re-ordered without departing from the scope of this disclosure. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context.

The method steps of the implementations described herein are intended to include any suitable method of causing such method steps to be performed, consistent with the patentability of the following claims, unless a different meaning is expressly provided or otherwise clear from the context. So, for example, performing the step of X includes any suitable method for causing another party such as a remote user, a remote processing resource (e.g., a server or cloud computer) or a machine to perform the step of X. Similarly, performing steps X, Y and Z may include any method of directing or controlling any combination of such other individuals or resources to perform steps X, Y and Z to obtain the benefit of such steps. Thus, method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

It should further be appreciated that the methods above are provided by way of example. Absent an explicit indication to the contrary, the disclosed steps may be modified, supplemented, omitted, and/or re-ordered without departing from the scope of this disclosure.

It will be appreciated that the methods and systems described above are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the spirit and scope of this disclosure and are intended to form a part of the invention as defined by the following claims, which are to be interpreted in the broadest sense allowable by law.

What is claimed is:

1. A computer program product comprising computer executable code embodied in a non-transitory computer readable medium that, when executing on one or more computing devices, performs the steps of:
training a teacher network including a first plurality of transformer layers to perform natural language processing using a large-scale natural language data set;
training a student network with a second plurality of transformer layers less than the first plurality of transformer layers to reproduce functions of the teacher network in a compressed model;
replacing at least one of the second plurality of transformer layers with an adapter first model to perform a natural language processing task to form a plurality of trained layers;
generating a second model by replacing a subset of trained layers in the second plurality of transformer layers of the student network with a number of adapters;
training the second model to perform a security classification task by fine-tuning the second model with a labelled target dataset specific to phishing detection; and
provisioning the second model in an enterprise network to perform the security classification task.

2. The computer program product of claim 1 wherein the natural language processing includes next sentence prediction.

3. The computer program product of claim 1 wherein the natural language processing includes masked word prediction.

4. The computer program product of claim 1 wherein the teacher network includes a Bidirectional Encoder Representation from Transformers model.

5. The computer program product of claim 1 wherein at least one of the number of adapters includes a randomly initialized, trainable adapter block interconnecting two of the transformer layers.

6. The computer program product of claim 1 wherein at least one of the number of adapters includes a fully connected dense layer having a same dimensionality as the second plurality of transformer layers.

7. The computer program product of claim 1 wherein at least one of the number of adapters includes an activation function for scaling inputs to outputs.

8. The computer program product of claim 1 wherein provisioning the second model includes deploying the second model on a threat management facility for the enterprise network.

9. The computer program product of claim 1 wherein provisioning the second model includes deploying the second model on an endpoint associated with the enterprise network.

10. A method, comprising:
training a first model to perform a natural language processing task to form a plurality of trained layers;
generating a second model by replacing at least one of the plurality of trained layers in the first model with an adapter and a residual connector;
training the second model to perform a security classification task to provide a trained second model; and
provisioning the trained second model in a system to perform the security classification task.

11. The method of claim 10 further comprising using the trained second model in the system to classify malicious communications.

12. The method of claim 10 wherein at least some of the trained layers from the first model are not modified during training of the second model.

13. The method of claim 10 wherein training the second model comprises modifying parameters in the adapter.

14. The method of claim 10 wherein the security classification task includes:
extracting words from a body and text of an email communication;
tokenizing one or more words into sub-word tokens; and
providing the sub-word tokens as input to an embedding layer of the second model.

15. The method of claim 10 wherein training the second model to perform the security classification task comprises training the second model using labeled email data.

16. The method of claim 10 further comprising providing message header features of an email communication to the trained second model including one or more of:
a first indication of whether a first domain of a sender matches a second domain of a receiver;
a second indication of whether the first domain of the sender matches a reply-to address;
a first number of recipients in a ‘To’ field; and
a second number of recipients in a ‘CC’ field.

17. A system, comprising a security classifier executing on a threat management resource of an enterprise network, the security classifier performing a classification task, and the security classifier generated by performing the steps of:
storing a model including a plurality of transformer layers configured to perform a natural language processing task;
generating a second model by replacing a subset of the plurality of transform layers in the model with adapters and adding an untrained classifier; and
training the second model to perform the classification task.

18. The system of claim 17 wherein the classification task comprises classification of maliciousness of messages.

19. The system of claim 17 wherein the classification task comprises identification of phishing email messages.

20. The system of claim 17 wherein the model includes a Bidirectional Encoder Representation from Transformers model.
